(19) United States
(12) Patent Application Publication
(10) Pub. No.: US 2005/0106451 A1
(43) Pub. Date: May 19, 2005

(54) Secondary battery with safety vents

(75) Inventors: Jun Ho Kim, Cheonan-si (KR); Seung Taek Hong, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD., Suwon-si (KR)

(21) Appl. No.: 10/967,179

(22) Filed: Oct. 19, 2004

(30) Foreign Application Priority Data
Oct. 20, 2003 (KR) 2003-72926

(51) Int. Cl. H01M 2/12

(52) U.S. Cl. 429/56; 429/82

(57) ABSTRACT

A secondary battery including a safety vent provided in a corner portion of a longitudinal surface of the secondary battery, wherein the safety vent is located in accordance with a distribution of tensile stress applied to the secondary battery during swelling generated due to internal pressure of the secondary battery.

### CROSS-REFERENCE TO RELATED APPLICATIONS

This application claims the benefit of Korean Patent Application No. 2003-72926, filed on Oct. 20, 2003, in the Korean Intellectual Property Office, the disclosure of which is incorporated herein by reference.

### BACKGROUND OF THE INVENTION

1. Field of the Invention

The present invention relates to a secondary battery, and more specifically, to a safety device of a secondary battery capable of preventing explosion thereof by reducing an internal pressure of the secondary battery when the internal pressure of the secondary battery is increased over a prescribed pressure.

2. Description of the Related Art

Recently, with the rapid advance of small-sized, light, and wireless electronic apparatuses such as camcorders, notebook computers, etc., small-sized and light secondary batteries having high energy densities have been increasingly required as driving sources of the electronic apparatuses. In this regard, lithium ion batteries have been receiving much attention. Since the lithium ion batteries have an energy density per unit weight that is typically three times higher than lead storage batteries, nickel-cadmium batteries, and nickel-hydrogen batteries, and can be rapidly charged, studies and developments on the lithium ion batteries are being actively pursued in many countries.

FIG. 1 is a perspective view illustrating a conventional lithium ion battery. As shown in FIG. 1, the lithium ion battery has a can 10 having a polygonal section surrounding and sealing an electrode assembly for generating current. A top surface of the can 10 is provided with a positive electrode terminal 12, and an electrolyte inlet 13 to inject an electrolyte into the can 10. A positive electrode plate and a negative electrode plate, between which a porous separator is interposed, are wound into a plurality of layers to form the electrode assembly in the can 10, and the positive electrode plate is electrically connected to the positive electrode terminal 12 provided in a cap assembly 11. In the lithium ion battery, if operational errors such as short-circuits, etc., take place in the electrode assembly sealed within the can 10, an internal pressure of the can 10 is increased, and thus the battery may explode. In order to prevent the explosion, a safety vent 14 is conventionally provided on a top surface of the can 10. For example, safety vents using tear lines provided on the top surface are disclosed in U.S. Pat. No. 4,245,010, and safety vents using a curbed portion provided on the top surface are disclosed in Japanese Unexamined Patent Application Publication No. Heisei 9-245839. In addition, safety vents using tear lines provided on a bottom surface of the can have been disclosed.

As a result, most of the conventional safety vents are provided on the top surface of the cap assembly or the bottom surface of the can, and are designed to be torn at a predetermined pressure. The vents are formed using a pressing or cladding technology, and it is difficult to keep a tear pressure below a predetermined pressure by using these vents. Therefore, theses vents make the manufacturing process more difficult, and also increase the cost of manufacturing. And when the internal pressure is increased to the point of causing deformation of the can, the pressure variation in the can is not rapidly coped with, so that it is not possible to effectively secure the safety of the battery.

### SUMMARY OF THE INVENTION

Accordingly, the present invention has been developed to solve the above and/or other problems, and it is thus an aspect of the present invention to effectively prevent explosion of a can by allowing the can to sensitively react to pressure, provide a large margin in designing or manufacturing vents, and reduce the cost by simplification of the manufacturing process.

In order to accomplish the above and/ or other aspects, the present invention provides a can structure capable of effectively preventing explosion of a can due to an internal pressure, by forming vents at portions of both large side planes of the can and thus allowing the vents to be easily torn, wherein tensile stress is most intensively generated in the above portions when the can is expanded due to the internal pressure.

Additional aspects and/or advantages of the invention will be set forth in part in the description which follows and, in part, will be obvious from the description, or may be learned by practice of the invention.

According to an aspect of the present invention, a second battery comprises a safety vent provided on a longitudinal surface of the secondary battery, wherein the safety vent is provided in an area defined by a first line extending from one end of a lateral side of the longitudinal surface at approximately a 35° angle to the lateral side, a second line extending from the one end of the lateral side at approximately a 70° angle to the lateral side, a first arc with a radius to the one end of the lateral side of approximately 5% of a diagonal length of the longitudinal surface, and a second arc with a radius to the one end of the lateral side of approximately 35% of the diagonal length of the longitudinal surface.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating a conventional lithium ion battery;

FIG. 2A is a Mises stress contour illustrating a tensile stress distribution in a large side plane of a can due to an internal pressure;

FIG. 2B is a diagram illustrating a three-dimensional shape of the large side plane of the can of FIG. 2A; and

FIGS. 3A and 3B are perspective views illustrating directions in which notches are formed at corner portions of the can.

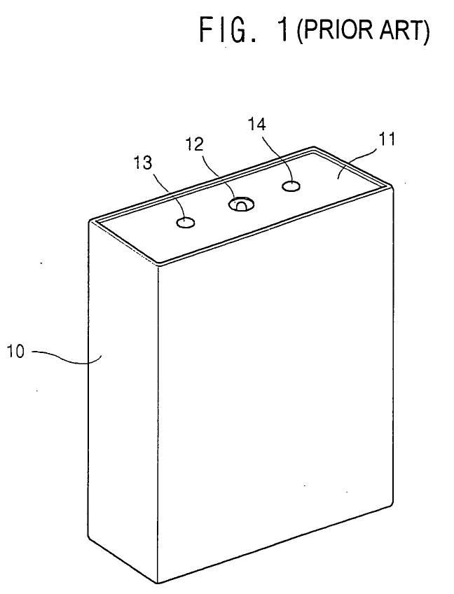

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

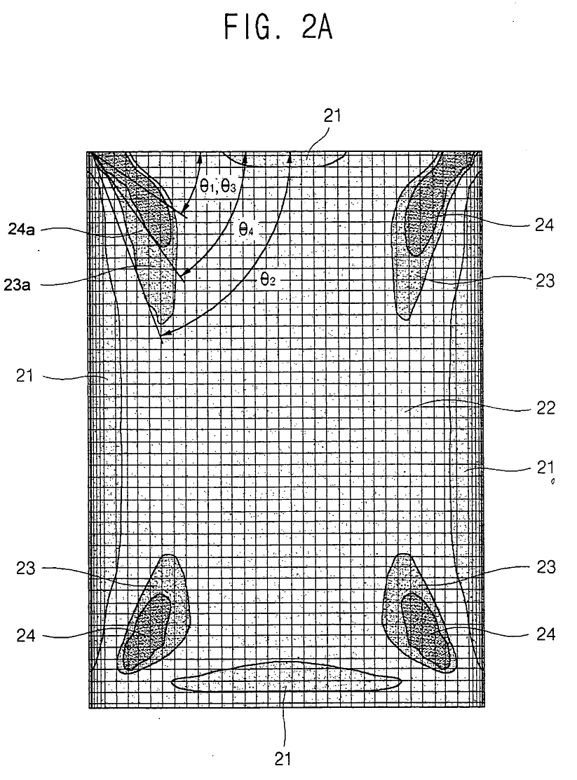

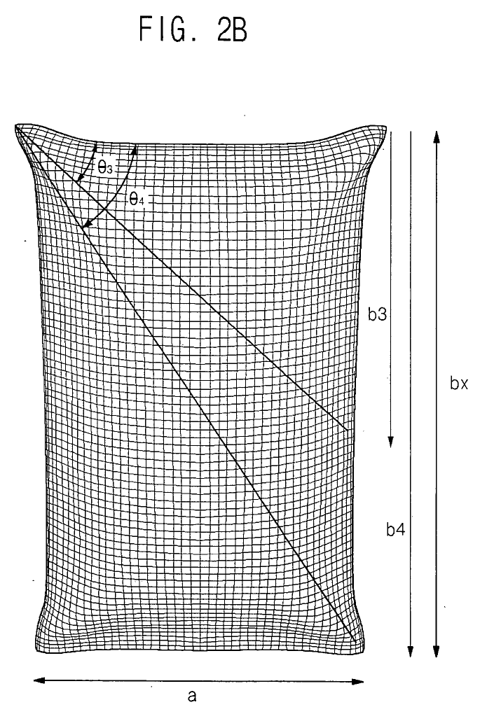

FIG. 2A shows a tensile stress distribution in a large side plane of a can due to an internal pressure, and FIG. 2B shows deformation of the large side plane of the can due to the internal pressure. The can comprises a packing material that has a thin rectangular parallelepiped shape, and isolates an electrode assembly and electrolyte therein from outsides thereof. In general, the can of a lithium ion battery itself is used as a positive electrode. The can is usually formed out of aluminum by using a deep drawing method.

Gas is generated in the can due to lithium carbonate Li₂CO₃ used in formation of a positive electrode active material such as lithium cobalt oxide LiCoO₂. The lithium carbonate excessively added remains in the lithium cobalt oxide LiCoO₂, which is the positive electrode active material, in a non-reaction state, and is decomposed when a voltage of the battery is increased and heat is generated due to the abnormal charging, thereby generating carbon dioxide gas. The swelling phenomenon in which the can is excessively expanded results from generation of the carbon dioxide gas, and when the swelling phenomenon is intensive, the safety vents, etc., are destroyed to emit the internal gas outwardly. The swelling phenomenon can be avoided by supplying only a stoichiometric amount of lithium carbonate, but, in this case, the cobalt oxide remains in the positive electrode active material. The remaining cobalt oxide corrodes the positive electrode, and is eluted into the electrolyte during charging. The eluted cobalt ions cause extraction of cobalt from the negative electrode, thereby causing an internal short-circuit, which is more dangerous. Therefore, the lithium carbonate should be excessively added in preparing the positive electrode active material.

A three-dimensional shape of the large side plane of the can (here, the can has a longitudinal side 48.7 mm and a lateral side 33.8 mm) in which the swelling phenomenon is generated due to the internal gas is shown in FIG. 2B, and the tensile stress distribution thereof is shown in FIG. 2A. In order to obtain FIGS. 2A and 2B, a simulation of deformation of a battery can due to the internal pressure is carried out using ABAQUS™, which is a commercial program for structure analysis, and the Mises stress contour of the can is obtained from the simulation. Positions suitable for the safety vents to which the stress is most intensively applied can be obtained on the basis of the figures.

Referring to FIGS. 2A and 2B, it can be seen that the tensile stress is increased in the order of edge portions 21 constituting edges of the can, plane portions 22, first corner portions 23, and second corner portions 24. That is, when the can is swelled due to the pressure of the internal gas, a large stress is generated in the corner portions 23 and 24.

A first corner portion 23a will now be described in more detail. A first inclination angle θ1 is illustrated by a line segment extending from one end of an upper lateral side of the can and passing through an upper portion of the area of increased tensile stress in the first corner portion 23a, the first inclination angle θ1 being the angle between the line segment and the upper lateral side of the can. The first inclination angle θ1 is approximately 35°. The second inclination angle θ2 is illustrated by another line segment extending from the one end of the upper lateral side of the can and passing through a lower portion of the area of increased tensile stress in the first corner portion 23a. The second inclination angle θ2 is approximately 70°. A majority of the area of increased tensile stress in the first corner position 23a lies between the two line segments forming angles θ1 and θ2, indicating the area in which to form the safety vent. A distance from the point at which each of the two line segments extend from the upper lateral side of the can by the first corner portion 23a occupies 0% through 35% of the total diagonal length of a longitudinal surface of the can. However, when a vent is formed in an area of 0% through 5% of the total diagonal length from a vertex of the corner, the vent may be damaged in subsequent processes such as welding the cap assembly to the can, so that an area where the vent can be formed is an area of approximately 5% through 35% of the total diagonal length from the vertex.

Next, the second corner portion 24a will be described in more detail. A third inclination angle Θ3 is illustrated by a line segment extending from the one end of the upper lateral side of the can and passing through an upper portion of the area of increased tensile stress in the second corner portion 24a (the area of increased tensile stress being brightly prominent in FIG. 2B), the third inclination angle θ3 being the angle between the line segment and the upper lateral side of the can. The third inclination angle θ3 is in the same area as the first inclination angle θ1. The fourth inclination angle θ4 is illustrated by another line segment extending from the one end of the upper lateral side of the can and passing through a lower portion of the area of increased tensile stress in the second corner portion 24a. The concrete values of θ3 and θ4 cannot be obtained at first hand. A majority of the area of increased tensile stress in the second corner position 24a lies between the two line segments forming angles θ3 and θ4, indicating a smaller area in which to form the safety vent than the area shown in the preceding discussion of the first corner position 23a. These angles are obtained from the Mises stress contour or the three-dimensional shape diagram of the large side plane in FIG. 2B by identifying a length of the lateral side as a, and a point where the line segments forming the inclination angle together with the lateral side come into contact with the longitudinal side as bx, and calculating the inclination angle from a ratio thereof.

Specifically, b3 from the third inclination angle and b4 from the fourth inclination angle are 0.7a and 1.48a, respectively, from analysis of the figures. The maximum and minimum inclination angles of the second corner portion 24a can be obtained by dividing the above values by a and applying a reversed function of tangent, that is, an arctangent, to the divided values. Therefore, the inclination angle of the second corner portion 24a having a high stress can be obtained from the following equation.
arc tan(0.7a/a)≦θ≦arc tan(1.48a/a)

From this equation, a range of the inclination angle of 35°≦θ≦55° is obtained.

A distance from the rotational center of the segment in the second corner portion 24a occupies 0% through 20% of the total diagonal length. Similarly to the first corner portion 23, an area in the second corner portion where the vent can be formed is an area of 5% through 20% of the total diagonal length.

From this simulation, it can be seen that the tensile stress generated in the can due to the internal pressure is concentrated on the corner portions, and thus the safety vent of the can is preferably provided in the corner portions 23 and 24 of the can, specifically, in the second corner portion 24.

It is preferable, though not necessary, that the shape of the vent be formed in a segment shape of a diagonal direction, but it may also be formed in a segment shape perpendicular to the diagonal direction.

The vents can be formed as weak portions, that is, notches, having a groove of a predetermined depth by using a mechanical method such as pressing, an etching method, or an electrical molding method. The shapes of the vents may be various shapes, such as a circular shape, a rectangular shape extending in one direction, etc. When the vent is formed to extend in one direction, it can be formed in a tear line shape. Here, when the notches are formed using the mechanical method, the etching method, or the electrical molding method, the depth or shape thereof should be uniform, so that operational errors resulting from errors in tearing due to the internal pressure, or errors resulting from a wide distribution, should be prevented.

Accordingly, the vents formed as notches are easily opened due to the internal pressure of the can. When an average thickness of the can is 0.3 mm, the thickness of the notches is set to 0.01 through 0.03 mm so that the notches can be smoothly opened with the internal pressure of 40 kgf/cm² or less. When the notches have a thickness of approximately 0.01 mm or more, the notches can be torn even by an external weak impact, so that it may be preferable that the notches are approximately 0.01 mm or more thick. On the contrary, when the notches have a thickness of approximately 0.03 mm or less, the can is not opened even with the internal pressure of 40 kgf/cm² or more, and operational errors of the vents can be caused, so that it may be preferable that the notches are approximately 0.03 mm or less.

In this embodiment, a method of reducing a thickness of a part of the can by a pressing process, etc. is used to form the vent, but a method of forming a hole penetrating a part of the can and then sealing the hole hermetically can be used. For example, a hole penetrating a part of the can is formed, and then a separate tear plate is attached thereto to seal hermetically the hole. In order to keep the operation of the tear plate more accurate and easily accomplished, a projection protruded toward a center of the hole may be formed. A tip of the projection is formed sharp to serve as a blade, so that the tear plate can first be torn. Adhesive other than welding may be used for easily attaching the tear plate. As the adhesive, polyethylenecoacrylic acid or mixtures of polyethylenecoarcrylic acid, isopropyl alcohol, and/or ammonia solvent may be used, and should not react with the electrolyte such as EC (ethylene carbonate), PC (propylene carbonate), EMC (ethyl methyl carbonate), DEC (diethylene carbonate), MEC, etc., which are received in the battery together with the electrodes. The tear plate to which the adhesive is applied is attached to the hole of the can, and is maintained in an oven of a temperature of approximately 60° C. to 70° C. for six hours for hardening and fixing. Also, since the can is usually made of aluminum (Al), it is preferable, though not necessary, that the tear plate is made of aluminum.

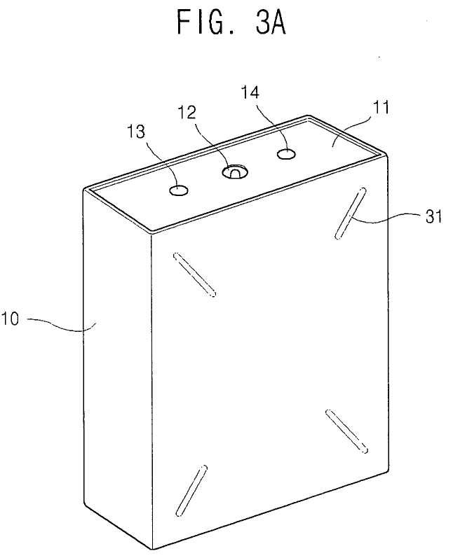

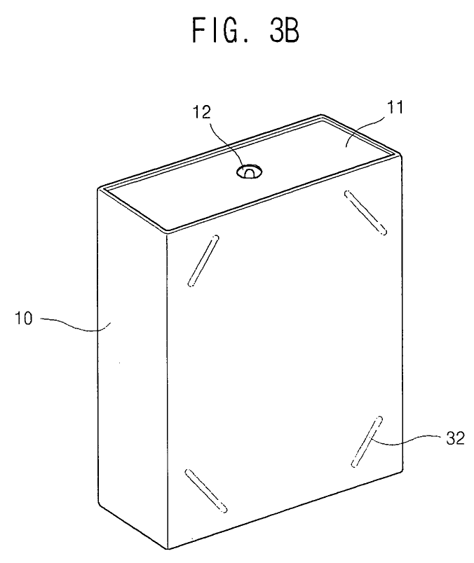

FIGS. 3A and 3B show directions in which the notches are formed at corner portions of the can. In FIG. 3A, the notch-shaped vents 31 are formed in the diagonal directions of the can 10, and in FIG. 3B, the notch-shaped vents 32 are formed in directions perpendicular to the diagonals of the can 10.

As described above, by providing the vents in accordance with distribution of tensile stress which is applied to the can during swelling of the can generated due to the internal pressure, the can is torn with a minimum internal pressure, so that it is possible to more effectively prevent explosion of the can. Furthermore, since the vents are provided on side planes of the can, a larger margin can be secured in designing or manufacturing the vents, and the cost can be largely reduced.

Although a few embodiments of the present invention have been shown and described, it would be appreciated by those skilled in the art that changes may be made in these embodiments without departing from the principles and spirit of the invention, the scope of which is defined in the claims and their equivalents.

1. A secondary battery, comprising:
a safety vent provided on a longitudinal surface of the secondary battery;
wherein the safety vent is provided in an area defined by:
a first line extending from one end of a lateral side of the longitudinal surface at approximately a 35° angle to the lateral side,
a second line extending from the one end of the lateral side at approximately a 70° angle to the lateral side,
a first arc with a radius to the one end of the lateral side of approximately 5% of a diagonal length of the longitudinal surface, and
a second arc with a radius to the one end of the lateral side of approximately 35% of the diagonal length of the longitudinal surface.

2. The secondary battery according to claim 1, wherein the the second arc has a radius to the one end of the lateral side of approximately 20% of the diagonal length of the longitudinal surface.

3. The secondary battery according to claim 1, wherein the second line extends from the one end of the lateral side at approximately a 55° angle to the lateral side.

4. The secondary battery according to claim 2, wherein the second line extends from the one end of the lateral side at approximately a 55° angle to the lateral side.

5. The secondary battery according to claim 3, wherein the safety vent has a depressed notch shape.

6. The secondary battery according to claim 4, wherein the safety vent has a depressed notch shape.

7. The secondary battery according to claim 1, wherein the safety vent is formed in a direction perpendicular to a diagonal direction of the longitudinal surface.

8. The secondary battery according to claim 2, wherein the safety vent is formed in a direction perpendicular to a diagonal direction of the longitudinal surface.

9. The secondary battery according to claim 7, wherein the safety vent has a depressed notch shape.

10. The secondary battery according to claim 8, wherein the safety vent has a depressed notch shape.

11. The secondary battery of claim 1, wherein the safety vent is a notch having a groove of a predetermined depth formed by a mechanical pressing, an etching method, or an electrical molding method.

12. The secondary battery of claim 11, wherein a thickness of a can containing the secondary battery is approximately 0.3 mm, and a thickness of the notch is approximately 0.01 mm to 0.03 mm.

13. The secondary battery of claim 12, wherein the can is formed of aluminum.

14. The secondary battery of claim 1, wherein the shape of the safety vent is circular or rectangular.

15. The secondary battery of claim 1, wherein the safety vent is formed in a tear line shape extending in one direction.

16. The secondary battery of claim 1, wherein the safety vent is formed by forming a hole penetrating the longitudinal surface and then sealing the hole hermetically.

17. The secondary battery of claim 16, wherein the hole is hermetically sealed by a separate tear plate.

18. The secondary battery of claim 17, further comprising a projection protruding from the secondary battery to the tear plate.

19. The secondary battery of claim 18, wherein a tip of the projection is formed sharp to serve as a cutting member.

20. The secondary battery of claim 17, wherein the tear plate is welded to the longitudinal surface.

21. The secondary battery of claim 17, wherein the tear plate is attached to the longitudinal surface by polyethylenecoacrylic acid or mixtures of polyethylenecoarcrylic acid, isopropyl alcohol, and/or ammonia solvent.

22. A secondary battery, comprising:
a safety vent provided in a corner portion of a longitudinal surface of the secondary battery;
wherein the safety vent is located in accordance with a distribution of tensile stress applied to the secondary battery during swelling generated due to internal pressure of the secondary battery.
